(19) United States
(12) Patent Application Publication
(10) Pub. No.: US 2003/0028394 A1
(43) Pub. Date: Feb. 6, 2003

(54) Computer system and method for automatically determining a customer price

(76) Inventors: Bernhard Alzer, Koln (DE); Klaus Zander, Mulheim (DE); Patric Enewoldsen, Burscheid (DE); Joachim Harder, Moskau (RU)

Correspondence Address: BAYER CORPORATION, PATENT DEPARTMENT, 100 BAYER ROAD, PITTSBURGH, PA, 15205, US

(21) Appl. No.: 10/191,308

(22) Filed: Jul. 9, 2002

(30) Foreign Application Priority Data
Jul. 10, 2001 (DE) 10133370.6

(51) Int. Cl. G06F 17/60

(52) U.S. Cl. 705/1; 705/26

(57) ABSTRACT

A computer system and method for automatically determining a customer price permit a customer price for an order with order parameters to be determined even if such an order has previously not been made by the customer. For this purpose, a similar order is determined from a customer history and the customer price for the new order is determined on the basis of the deviation of the earlier similar order from a standard price.

### BACKGROUND

The invention relates to a computer system and method for automatically determining a customer price.

From the prior art it is known to provide, market and sell products and services electronically, for example via the Internet. This applies equally to services and products aimed at the end user, in particular for what is referred to as the “business to consumer” field, and to commerce between institutions, in particular for what is referred to as “business to business” field.

For example, banks, companies which sell consumer goods, telecommunications and electronics companies or the car industry use the Internet for what is referred to as e-business platforms or portals, for offering their respective products and/or services.

The setting up of such e-business platforms plays a particularly important role for the chemical industry because the wide-ranging automation of the goods supply chain will lead to significant cost reductions. A distinction is made here between company portals, marketplaces (for example Omnexus) and purchasing platforms (for example Covisint).

Further examples of such e-business platforms are CC-MARKETS and “Elemica.” Elemica was founded by twenty-two of the largest chemical companies in the world; it is a marketplace through which basic, special and fine chemicals can be ordered. Such a marketplace is particularly advantageous in the chemical industry.

This applies both to the exchange of goods between chemical companies and also to sales to customers outside the chemical industry. A corresponding platform of functions makes available a catalogue of products and functions for processing contracts and for calling the agreed delivery at the respective time. In addition, transport planning and stockkeeping are to be controlled electronically at the same time. These are functions which are of great importance particularly when trading chemicals.

According to the prior art, there are basically two possible automatic ways of determining the customer price for online trading:

i) a customer-specific price for the ordered product has previously been negotiated with the customer. This price is stored in a customer price register. When an online order of the respective product is made, the customer price stored in the customer price register is accessed.

ii) in the event of there being no previously negotiated customer price stored in the customer price register, for the ordered product, a standard price is used for the pricing process.

The pricing process using the standard price has the disadvantage that it either does not meet the expectations of the customer or has to be set at such a low level that possibilities of making a return are lost.

The invention is therefore based on the object of providing an improved computer system and method for automatically determining a customer price.

The object on which the invention is based is respectively achieved with the features of the independent patent claims. Preferred developments of the invention are given in the subclaims.

### SUMMARY

The invention relates to a method for automatically determining a customer price for an order with ordering parameters comprising (a) searching for an earlier order with similar ordering parameters, (b) determining a standard price for a similar order, (c) determining a deviation of the actual price of the similar order from a standard price of the similar order, (d) determining the standard price for the order, and (e) determining the customer price for the order, taking into account the difference between the actual price of the similar order from the standard price of the similar order.

The invention also relates to a computer system for automatically determining a customer price for an order with order parameters comprising (a) a means for searching for an earlier order with similar order parameters, (b) a means for determining a standard price for the similar order, (c) a means for determining the deviation of the price of the similar order from the standard price of the similar order, (d) a means for determining the standard price for the order, (e) a means for determining a customer price for the order taking into account the deviation.

The invention also relates to a computer program product on a computer-readable medium with computer-readable program means for carrying out a a method for automatically determining a customer price for an order with ordering parameters comprising (a) searching for an earlier order with similar orderingparameters, (b) determining a standard price for the similar order, (c) determining the deviation of the actual price of the similar order from the standard price of the similar order, (d) determining the standard price for the order, and (e) determining the customer price for the order taking into account the difference, such that the program can be executed by a computer.

### DESCRIPTION OF THE FIGURES

These and other features, aspects, and advantages of the present invention will become better understood with reference to the following description and appended claims, where:

FIG. 1 shows a flowchart of an embodiment of the method according to the invention,

FIG. 2 shows a development of the method in FIG. 1,

FIG. 3 shows a computer system for executing the method.

### DESCRIPTION

The invention permits a customer price for a product or a service which has previously not been ordered by the customer in the same form and for which no previously negotiated price is available to be determined automatically. This permits orders with different order parameters to be processed automatically via the Internet without the time-consuming and costly involvement of a sales representative to negotiate a customer price being necessary.

A particular advantage of the invention lies in the fact that, despite the automatic determination of the customer price, there is a high probability that the expectations of the customer in respect of the price can be met, and at the same time the manufacturers return is optimized.

The invention thus permits a price request to be responded to quickly in real time, even for products which have previously not yet been ordered by the customer. The pricing process is thus greatly rationalized without having to dispense with a customer-specific price.

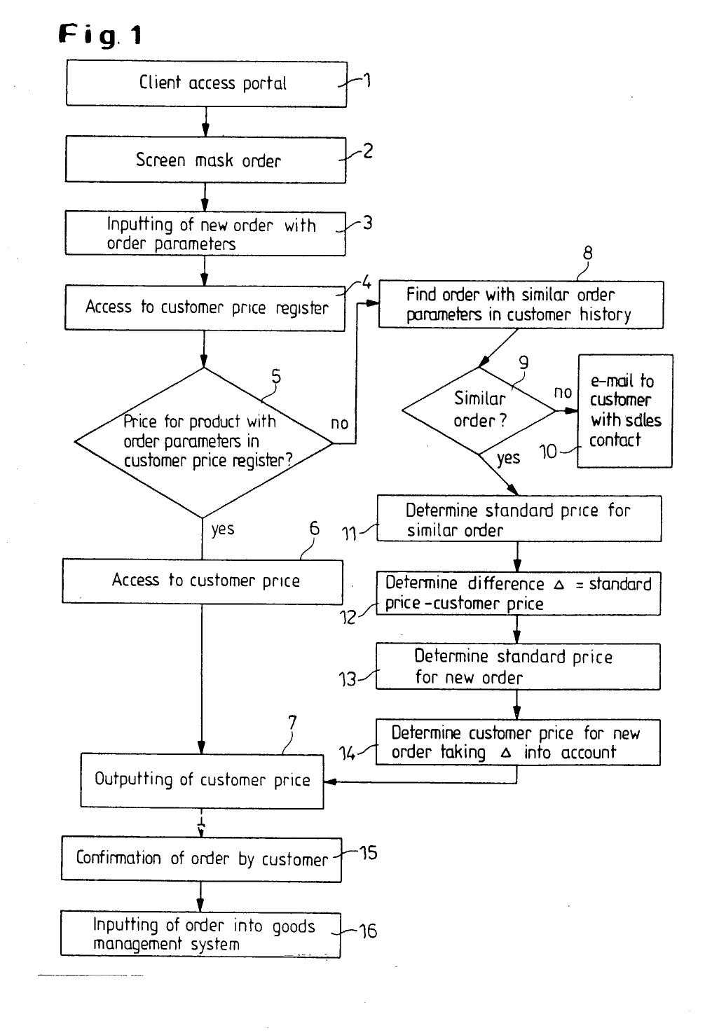

A preferred exemplary embodiment of the invention will be explained in more detail below with reference to the FIGS. 1, 2, and 3.

In the flowchart in FIG. 1, in step 1 a customer access to an e-business portal takes place. For this purpose, the customer uses a client computer which uses a computer network, for example the Internet, to access a server computer on which the website of the portal is implemented.

In step 2, a screen mask for the inputting of an order and/or price request with specific order parameters is displayed on the screen of the client computer. The customer enters the new order and/or price request with the corresponding order parameters in step 3.

This order and/or price request with the order parameters is transmitted to the server computer. The server computer then accesses a customer price register in step 4 in order to check in step 5 whether a price which has been previously negotiated with the customer for the corresponding product is stored with the order parameters in the customer price register. If this is the case, this customer price is accessed in step 6 and this customer price is transmitted to the client computer so that in step 7 said customer price is output on the screen of the client computer.

If it is decided in step 5 that there is no customer price present in the customer price register for the new order with the order parameters, the sequence controller goes to step 8 so as to find a similar order in a customer history which has similar order parameters. In step 9, it is checked whether there is such a similar earlier order in the customer history. If this is not the case, in step 10 a message, for example an e-mail, to the customer and sales representative is generated. The message contains a sales contact, for example the telephone number of a sales representative. The customer can then call the sales representative in order to negotiate the customer price individually. Alternatively, or in addition, a message with all the order information is transmitted to the sales representative, so that the sales representative can make contact with the customer to negotiate the price.

On the other hand, if it is decided in step 9 that a similar order is present in the customer history, in step 11 the standard price for the earlier similar order is determined by a corresponding database access with the order parameters.

In step 12, the difference between the standard price determined in step 11 and the customer price of the similar order is determined from the customer history.

In step 13, the standard price for the new order with the corresponding order parameters is determined by means of a database access. In step 14, the customer-specific price of the new order is finally determined taking into account the difference determined in step 12.

For this purpose, for example, the difference determined in step 12 can be subtracted from the standard price for the new order which is determined in step 13. In addition, further customer-specific parameters, for example a customer-specific progressive price reduction as a function of the quantity ordered, the overall quantity ordered and/or the quantity ordered per year, as well as the region and/or the industrial sector, can be taken into account here.

If the similar order which is determined from the customer history has already existed for a relatively long period of time during which one or more price adaptations of the standard prices have taken place, it is advantageous to adapt the actual customer price from the customer history for the similar earlier order according to the percentage change in the standard prices in order to form the difference in step 12 to relate the earlier customer price to the current price conditions.

After the customer price is determined in step 14, it is transmitted by the server computer to the client computer and in turn displayed there on the screen of the client computer in step 7.

In step 15, the customer can confirm the order with the customer price obtained in step 7. This can take place online, for example by clicking on an “OK” button in order to input the confirmation and transmit the confirmation to the server computer.

In step 16, the order is input at the server end into a goods management system for automatic processing of the delivery, payment etc. For this purpose it is possible to use, for example, a goods management system from SAP AG, for example SAP-R3.

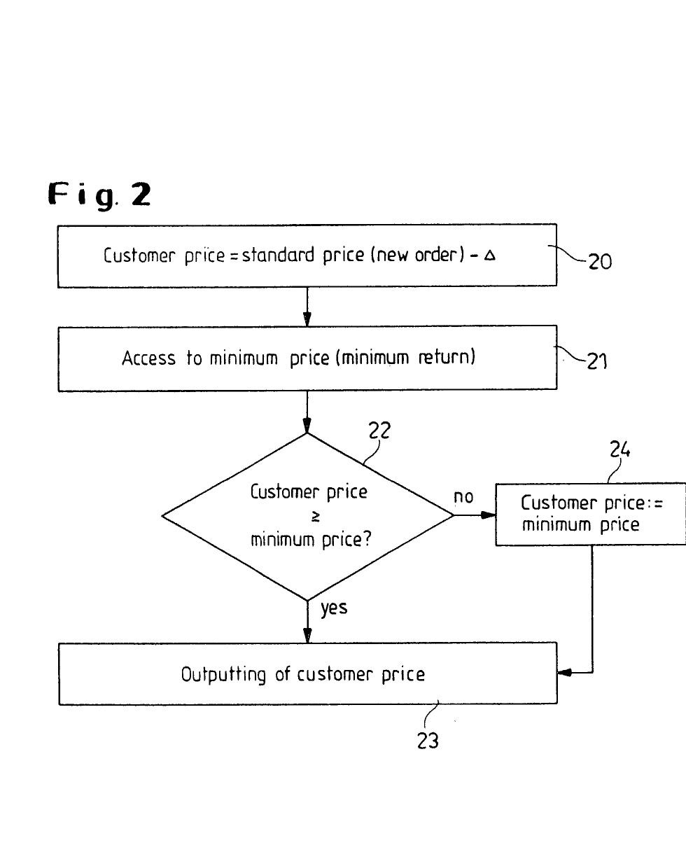

FIG. 2 shows a development of the method in FIG. 1 in which it is ensured that a minimum return is achieved with the automatically determined customer price. For this purpose, in step 20, which corresponds to step 14 of FIG. 1, the customer price is firstly determined from the standard price of the new order (cf. step 13 in FIG. 1) by subtracting the difference between the standard price and the customer price of the earlier order (cf. step 12 in FIG. 1).

In step 21, a minimum price for the new order with the order parameters is determined in order to achieve a minimum return. This can be done by means of a calculation rule which is integrated into a corresponding business information system.

In step 22, the customer price of step 20 is then compared with the minimum price of step 21.

If the customer price of step 20 is higher than or equal to the minimum price of step 21, the customer price of step 20 is at the same time the final customer price which is output in step 23.

If, on the other hand, the customer price of step 20 is less than the minimum price, the customer price is increased to the minimum price in step 24 in order to ensure that the minimum return is achieved. Then, the outputting of the customer price of step 24 takes place again in step 23.

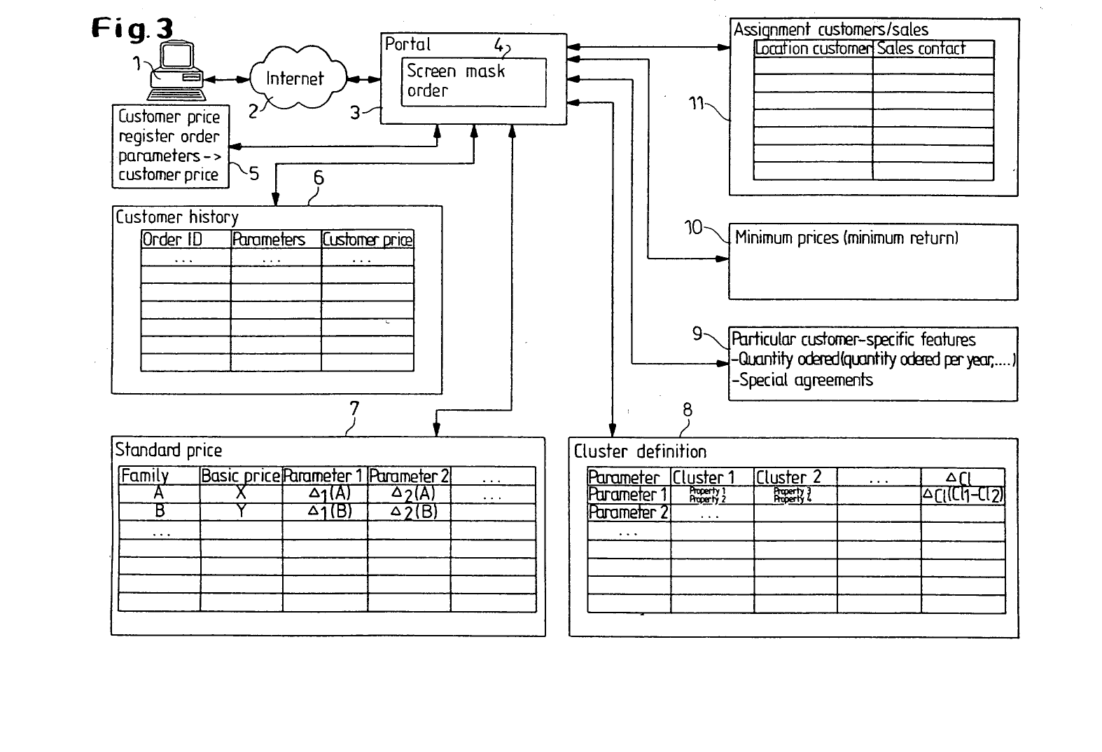

FIG. 3 shows a computer system according to the invention with a client computer 1 which can access an e-business portal 3 of a server computer via the Internet 2. The portal 3 has a screen mask 4 which can be transmitted to the client computer 1 as a result of the client computer 1 accessing the server computer via the Internet 2, with the result that a customer can input an order with the associated order parameters into the screen mask 4.

The portal 3 is also connected to the customer price register 5 via the corresponding server computer. The customer prices for predefined orders with specific order parameters are stored in the customer price register. If an order is input with order parameters for which a price is present in the customer price register, this price can be called from the customer price register 5 and transmitted to the client computer 1. This is the case, for example, if customer prices have previously been individually negotiated with the customer for specific standard orders.

The portal 3 is also connected to a database 6. The database 6 stores the customer history. An entry in the customer history is composed of the identification number “ID” of the order, the order parameters and the corresponding customer price.

In addition, the portal 3 is connected to a database 7 for determining the standard price. The database 7 contains the respective basic prices X, Y . . . for various product families A, B. . . . The database 7 contains deviations from the basic price as a function of the order parameters (parameter 1, parameter 2 . . . ). For the example of product family A and the corresponding basic price X, these are the deviations Δ₁(A) and Δ₂(A) for the parameters 1 and 2, respectively. The deviations for the further parameters are not illustrated in FIG. 3. Correspondingly, the deviations Δ₁(B) and Δ₂(B) for the parameters 1 and 2 with respect to product family B and its basic price Y are contained in database 7.

The portal 3 is also connected to a database 8. The database 8 has an entry for each of the parameters (parameter 1, parameter 2 . . . ). Each of the parameters can assume different instances, for example properties or numerical values. Such properties or ranges of numerical values are assigned to different clusters (cluster 1, cluster 2 . . . ). For example, the instances “property 1” and “property 2” of the parameter 1 are assigned to the cluster 1, while the properties “property 3” and “property 4” of the parameter 1 are assigned to the corresponding cluster 2.

In addition, each entry in the database 8 contains at least one weighting Δ_{CL} for weighting a deviation of a parameter. If, for example, a first parameter instance is assigned to the cluster 1 and another parameter instance to the cluster 2, the weighting of the deviation of the parameter properties is given by the database entry Δ_{CL}(CL1-CL2). If more than two clusters are defined for a specific parameter, the database 8 can contain the weightings for all the permutations of the deviations between clusters.

The similarity of two orders can be determined using the database 8. If, for example, the corresponding instances of the parameter 1 are associated with different clusters, this deviation is evaluated with the corresponding weighting Δ_{CL}(CL1-CL2). A corresponding method is adopted for the further parameters. The corresponding weightings of the deviations with respect to the assignment of instance parameters to clusters can then be summed. The summed weightings then constitute a measure of the similarity of the cluster profiles of the orders to be compared. If the sum of the weightings exceeds a specific value, the compared orders are considered as being dissimilar; on the other hand, if the summed weightings drop below the predetermined value, the orders are similar orders.

The portal 3 is also connected to a database 9. The database 9 contains particular customer-specific features, for example customer-specific agreements in respect of pricing. For example, a particular progressive price reduction as a function of the quantity ordered, the quantity ordered of a particular product per year or the overall quantity ordered may have been agreed with the customer.

The portal 3 is also connected to the module 10 for determining a minimum price in order to achieve a minimum return. The module 10 can be a calculation rule which is integrated into a business information system.

In addition, the portal 3 is connected to a database 11. An assignment between the location of the customer and a corresponding sales contact is stored in the database 11. The sales contact can comprise, for example, contact information of the sales representative for the area in which the customer is based.

If the customer inputs an order into the screen mask 4 via the client computer 1, the corresponding data is transmitted to the portal 3. The portal 3 then firstly tests whether an order with the corresponding parameters is stored in the customer price register 5 and, if appropriate, determines the customer price from the customer price register 5. On the other hand, if such an order is stored in the customer price register 5, the portal 3 accesses the database 6 in order to determine a similar order from the customer history. For this purpose, firstly a corresponding cluster profile is generated for a candidate for a similar order by means of the database 8, that is to say the instances of the parameters of the earlier order are assigned to the corresponding clusters. The cluster profile then results from the assignment of parameter instances to clusters. A corresponding procedure is adopted with the new order and the parameter values instanced by the customer during the inputting by means of the screen mask 4. Here, a similar order with the same cluster profile can be determined from the customer history.

If such a similar order with the same cluster profile cannot be found, the sum of the weightings of the deviations can be formed for the candidate for the similar order and for the order so that a decision regarding the similarity or dissimilarity can be made.

If a similar order cannot be determined from the customer history, an access is made to the database 11 in order to interrogate an assignment of the customer to a sales contact. Subsequent to this, a message can be generated automatically in order to ask the customer to, for example, make contact by telephone with a sales representative for the purpose of negotiating a customer price. This message can be sent to the customer by the portal 3 via the Internet 2 to the client computer 1 by e-mail. This message can also contain a price determined from the database 7 and can allow the customer to decide whether he would like to accept the standard price or whether he prefers to contact a sales representative in order to negotiate an individual price.

Alternatively, or in addition, a message is transmitted to the sales representative with all the order information so that the sales representative can contact the customer to negotiate the price.

If, on the other hand, a similar order can be determined from the customer history, the standard price is determined for the similar order from the database 7 taking into account the instances of the parameters of the respective similar order. The difference between the standard price and the customer price of the similar order is then formed. If the similar order has been made some time before, the customer price of the earlier similar order can be adapted in accordance with price changes. This is then followed by the determination of the standard price for the new order on the basis of the database 7. The previously determined difference is then subtracted from this standard price. In addition, it is possible to access the database 9 in order to take into account further particular customer-specific features, for example further price reductions. The customer price which is determined in this way is then prepared with a minimum price determined from the module 10. If the customer price is higher than the minimum price, this price is transmitted to the client computer 1; if the opposite is the case, the minimum price is transmitted.

The parameters of an order may comprise in the case of the technical thermoplasts from Bayer AG, the following by way of example:

Parameter 1=family: Apec HT, Makrolon, Makrofol/Bayfol, Lustran ABS/Novodur, Lustran SAN, Bayblend, Triax, Centrex/Cadon, Durethan, Pocan, BAK, Desmopan/Texin.

Parameter 2=type:

Types for Apec HT:

. . .

types of Durethan:

non-reinforced injection molding types, reinforced injection molding types, standard injection molding types, flame-retardant injection molding types, impact-resistant modified injection molding types, transparent injection molding types, glass fibre, glass fibre flame-retardant, impact-resistant modified glass fibre, glass fibre with reduced water absorption, mineral filled, mineral flame-retardant, mineral impact-resistant modified, jacket material and glass fibre, jacket material and glass fibre flame-retardant.

Parameter 3=variant: . . .

variant for Durethan standard injection molding types:

thermally stabilized, additionally nucleated, greater degree of toughness . . .

Parameter 4=color

Parameter 5=packaging

Parameter 6=region

Parameter 7=industrial sector

Parameter 8=quantity ordered

List of reference numerals

| | |
|---|---|
| Client computer | 1 |
| Internet | 2 |
| Portal | 3 |
| Screen mask | 4 |
| Customer price register | 5 |
| Database | 6 |
| Database | 7 |
| Database | 8 |
| Database | 9 |
| Module | 10 |
| Database | 11 |

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method for automatically determining a customer price for an order with ordering parameters comprising:
(a) searching for an earlier order with similar ordering parameters,
(b) determining a standard price for a similar order,
(c) determining a deviation of the actual price of the similar order from a standard price of the similar order,
(d) determining the standard price for the order,
(e) determining the customer price for the order, taking into account the difference between the actual price of the similar order from the standard price of the similar order.

2. The method according to claim 1, wherein a difference between the standard price for the order and the deviation is formed in order to determine the customer price.

3. The method according to claim 1, wherein additional customer-specific data selected from the group consisting of (i) the quantity ordered, (ii) the quantity ordered per year or the overall quantity ordered, and (iii) combinations thereof is taken into account when determining the customer price for the order.

4. The method according to claim 1, wherein a change in the standard prices over time being taken into account when determining the price of the similar order.

5. The method according to claim 1, wherein for the search for an earlier order with similar order parameters, clusters of instances of the parameter are formed for each of the parameters.

6. The method according to claim 5, wherein in order to search for an earlier order with similar order parameters, the order parameters of the order are each assigned to a cluster of the corresponding order parameters and an earlier order with the same cluster profile is searched for.

7. The method according to claim 6, wherein if no earlier order with the same cluster profile is found, an earlier order with a similar cluster profile is searched for, so that it is possible to provide deviations from cluster assignments of the earlier order and of the order with different weightings.

8. The method according to claim 7, wherein if the sum of the weightings exceeds a predetermined threshold value, no earlier order with similar order parameters is present.

9. The method according to claim 1, wherein if no earlier order with similar order parameters is found, a message is generated to the customer.

10. The method of claim 9, wherein the message is an e-mail.

11. The method according to claim 9, wherein, in order to generate the message to the customer, a sales database is accessed to determine the sales contact for the customer.

12. The method according to claim 1, wherein if the determined customer price is compared with a minimum price and if the previously determined customer price is lower than the minimum price, the customer price is increased to the minimum price.

13. The method according to claim 1, wherein the order parameters are selected from the group consisting of product family, product type, product variant, product color, product packaging, and combinations thereof.

14. The method according to claim 1, wherein the standard prices are determined as a function of the region and/or the industrial sector.

15. A computer system for automatically determining a customer price for an order with order parameters comprising:
(a) means for searching for an earlier order with similar order parameters,
(b) means for determining a standard price for the similar order,
(c) means for determining the deviation of the price of the similar order from the standard price of the similar order,
(d) means for determining the standard price for the order,
(e) means for determining a customer price for the order taking into account the deviation.

16. The computer system according to claim 15, wherein the system comprises:
(a) a server computer for communicating with a client computer via a computer network,
(b) a first database for storing a customer history of earlier orders with the corresponding order parameters, and
(c) a second database for determining a standard price as a function of the order parameters.

17. The computer system of claim 16, wherein the computer network is the Internet.

18. The computer system according to claim 15, wherein the system further comprises a third database or storing parameter clusters.

19. The computer system according to claim 18, wherein the third database has weightings, for the purpose of storing parameter clusters and for evaluating the deviation of the cluster profile of the order from an earlier order.

20. The computer system according to claim 18, wherein the system further comprises a fourth database for storing customer-specific parameters

21. The computer system of claim 20, wherein the fourth database comprises a progressive price reduction as a function of the quantity ordered, the quantity ordered per year and/or the overall quantity ordered across all products.

22. The computer system according to claim 15, wherein the computer system has a means for determining a minimum price for achieving a minimum return for the order.

23. The computer system according to claim 15, wherein the system further comprises a fourth database for storing an assignment of the location of the customer and of a sales contact.

24. A computer program product on a computer-readable medium with a computer-readable program means for carrying out a a method for automatically determining a customer price for an order with ordering parameters, in which the method comprises:
(a) searching for an earlier order with similar ordering parameters,
(b) determining a standard price for the similar order,
(c) determining the deviation of the actual price of the similar order from the standard price of the similar order,
(d) determining the standard price for the order,
(e) determining the customer price for the order taking into account the difference, wherein the program can be executed by a computer.
